(19) United States
(12) Patent Application Publication
(10) Pub. No.: US 2021/0166158 A1
(43) Pub. Date: Jun. 3, 2021

(54) SYSTEM AND METHOD FOR CONTROLLING MULTIPLE DEVICES THROUGH FEDERATED REINFORCEMENT LEARNING

(71) Applicant: Korea University Of Technology And Education Industry-University Cooperation Foundation, Cheonan-si (KR)

(72) Inventors: Youn Hee HAN, Daejeon (KR); Hyun Kyo LIM, Cheonan-si (KR); Chan Myung KIM, Cheonan-si (KR); Ju Bong KIM, Cheongju-si (KR); Gyu Young HWANG, Cheonan-si (KR); Ho Bin CHOI, Cheonan-si (KR)

(21) Appl. No.: 17/098,320

(22) Filed: Nov. 13, 2020

(30) Foreign Application Priority Data
Dec. 2, 2019 (KR) 10-2019-0157925

(51) Int. Cl. G06N 20/20; G06F 17/18

(52) U.S. Cl. CPC G06N 20/20; G06F 17/18

(57) ABSTRACT

The present disclosure relates to a system and method for controlling multiple devices through a federated reinforcement learning, in more detail, in case of performing the reinforcement learnings for controlling each of a plurality of devices in each of the plurality of devices, provided a system and method for controlling multiple devices through the federated reinforcement learning to be able to precisely control the plurality of devices using the reinforcement learning result as well as to finish the reinforcement learning at high speed, by performing a coalition of the reinforcement learning in the plurality of device controllers, through a gradient sharing process shared with the plurality of device controllers by averaging the gradients for each of the reinforcement learnings and a learning parameter transfer process transferring the learning parameter of a particular device controller that a reinforcement learning is terminated first through the gradient sharing process to at least one device controller that the reinforcement learning is not completed yet.

### TECHNICAL FIELD

The present disclosure relates to a system and method for controlling multiple devices through federated reinforcement learning, in more detail, when performing the reinforcement learning for controlling each of a plurality of devices in each of the plurality of devices, provided the system for controlling multiple devices and the method through the federated reinforcement learning to be able to precisely control the plurality of devices using the reinforcement learning result as well as to finish the reinforcement learning earlier, by performing a coalition of the reinforcement learning in the plurality of device controllers, through a gradient sharing process shared with the plurality of device controllers by averaging the gradients for each of the reinforcement learnings and a learning parameter transfer process transferring a learning parameter of a particular device controller that a reinforcement learning is terminated first through the gradient sharing process to at least one device controller that the reinforcement learning is not terminated yet.

### ACKNOWLEDGEMENT

This invention was made with the support from Basic Science Research Program (2018R1A6A1A03025526) and the BK-21 plus program through the National Research Foundation (NRF) funded by the Ministry of Education, Republic of Korea.

### BACKGROUND

Recently, in accordance with a rapid development of industrial technology and information and communication technology, a variety of devices are being developed to handle each of their tasks while having each of their unique functions.

These devices are handled on behalf of tasks that are time-consuming for a person directly to process or are dangerous work or work that is difficult for a person to deal with, so that these provide stability and convenience to a person. Thus, the device control systems for more convenient control of these devices have been developed.

However, since conventional device control systems are implemented in the form of which a user directly manipulates to control the devices, it may occur a problem that does not properly achieve the purpose of the work in case that a high precision is required for the operation of the devices.

In recent years, so as to solve this problem, artificial Intelligence-based device control systems that allows more accurate and precise control of the devices by combining the artificial intelligence on the devices have been developed and commercialized.

The artificial Intelligence-based device control systems should basically build a learning model for controlling the devices, and the learning model is generated by performing a learning process for training a plurality of learning data generated for the operation of the devices.

However, the learning process for building the learning model takes a long time, in case of performing the training using a small number of learning data, there is a problem that the accuracy of the learning model is significantly reduced.

Therefore, in a plurality of device controllers, in case of performing the reinforcement learning for controlling each of a plurality of devices in each of the plurality of devices, presented a method for precisely controlling the multiple devices, by ensuring that the reinforcement learning performed by the plurality of device controllers proceeds accurately and quickly, through the reinforcement learning configured to be a federated reinforcement learning comprising a gradient sharing process shared with the plurality of device controllers by averaging the gradients for each of the reinforcement learnings performed in the plurality of device controllers, and a learning parameter transfer process providing a learning parameter that a reinforcement learning is terminated through the gradient sharing process in a particular device controller to at least more than one of device controllers that the reinforcement leanings are not terminated yet.

Next, prior arts existing in the art of the present disclosure are briefly described, and then the technical matters to achieve differentially compared to the prior art are described.

First, Korean Patent No. 2019-0101677 A1 (2019 Sep. 2) a system for determining control parameters for accelerator performance optimization using reinforcement learning and machine learning techniques, in more details, comprises: training the change to the value of the control parameters for controlling the accelerator and corresponding final output quality of the accelerator through the artificial neural network-based learning process and calculating the value of the control parameters that the final output quality of each accelerator is to be the highest using the results learned from the controllers of the plurality of accelerators, in a plurality of device simulators corresponding to each of multiple controllers of the plurality of accelerators.

The prior art is to control a plurality of devices called accelerators through a method of an artificial intelligence, but it is to individually perform a learning process for controlling each of the accelerators through a plurality of device simulators for a plurality of accelerators.

On the other hands, the present disclosure is to quickly terminate all the reinforcement learning and at the same time enable precise control of the plurality of devices using the learning model generated through the reinforcement learning, through setting a learning parameter of a specific learning model in which the reinforcement learning is completed first as the learning parameter of other learning models in which the reinforcement learning has not been completed by applying an average of the gradients calculated in each reinforcement learning process to each of the reinforcement learnings, when generating a learning model for controlling a plurality of devices through the reinforcement learning in the plurality of device controllers. Therefore, the prior art does not describe or suggest the technical features of the present disclosure.

In addition, KR2019-0103088 (2019 Sep. 4) provides a method and apparatus for recognizing a business card of a terminal through federated learning, including receiving an image of the business card; extracting a feature value from the image including text related to a field of an address book set in the terminal; inputting the feature value into a first common prediction model and determining first text information from an output of the first common prediction model; analyzing a pattern of the first text information and inputting the first text information into the field; caching the first text information and second text information received for error correction of the first text information from a user; and training the first common prediction model using the image, the first text information, and the second text information, whereby each terminal may train and share the first common prediction model.

That is, the prior art shares the first common prediction model by providing first text information and second text information from a plurality of terminals to a central server to learn a first common prediction model built in the central server, and thus there are obvious differences between the prior art and the present disclosure, because the prior art fails to disclose technical features of the present disclosure related to perform the federated reinforcement learning that federates the reinforcement learnings for each individual of the device controllers, by continuing the reinforcement learning through averaging the gradients calculated in the process of performing reinforcement learning for controlling each device and sharing the averaged gradients with other device controllers, and by applying, in case of completing the reinforcement learning in one device controller, a learning parameter of the device controller to reinforcement learnings of other device controllers, in each of the device controllers for controlling the plurality of devices.

Each of multiple devices produced in even the same factory line has different dynamics, thus there are problems to be solved on performing independent precision control through reinforcement learning for each device, that is, the deep learning model parameters (i.e., weights and bias) converge to slightly different values according to each of the devices, and it takes a long time to complete trainings of all devices.

### SUMMARY

The present disclosure was devised so as to resolve the problems of the state of the art mentioned above, an object of the present disclosure is to provide a system for controlling multiple devices and a method for controlling the device through a federated reinforcement learning that enables efficient and precise control of the device by generating each learning model capable of automatically controlling each of the devices through reinforcement learning in each of device controllers for a plurality of devices having similar or same characteristics and purposes.

In addition, another object of the present disclosure is to provide a system for controlling multiple devices and a method for controlling the devices through a federated reinforcement learning that is possible to quickly complete the reinforcement learning of each device controller and create the reinforcement learning model that enables precise control of the device by constituting the reinforcement learning performed when each device controller generates a learning model for controlling the device with the federated reinforcement learning comprising a gradient sharing process of averaging the gradient calculated in the currently performed reinforcement learning and sharing the averaged gradient to the device controller and a learning parameter transfer process that transfers a learning parameter of a specific device controller for which the corresponding learning process is completed to other device controllers in case that the learning process in the specific device control device is completed after performing the gradient sharing process.

In addition, another object of the present disclosure is to provide a system for controlling multiple devices and a method for controlling the devices through a federated reinforcement learning that is possible to continuously precisely control the device to be adapted to aging or changes in the surrounding environment of the device, through the learning model update by performing the federated reinforcement learning in case that the device is not properly controlled due to aging or changes in the surrounding environment of the device when actually controlling the device using the generated learning model in each of the device controllers.

A system for controlling multiple devices through a federated reinforcement learning in accordance with an embodiment of the present disclosure, comprising a plurality of service controllers configured to perform the reinforcement learning to control each of the plurality of devices and report the gradient calculated in the process of the reinforcement learning and a learning parameter according to the completion of the reinforcement learning to a federated reinforcement learning managing server; and the federated reinforcement learning managing server configured to average the reported gradients, share the averaged gradient with the plurality of device controllers, and transfer the reported learning parameter to at least more than one of the devices in which the reinforcement learning has not been completed, wherein the system is characterized in that the overall reinforcement learning is completed earlier than individual reinforcement learning by performing the federated reinforcement learning in coalition with the reinforcement learnings through the sharing of the averaged gradient and the transferring of the learning parameter.

Wherein the plurality of device controllers further configured to comprise a federated reinforcement learning unit that generates a learning model for controlling the device through the federated reinforcement learning, the federated reinforcement learning unit further configured to comprise a gradient reporting unit that calculates the gradient for the reinforcement learning currently being performed according to the request of the federated reinforcement learning managing server and reports the calculated gradient to the federated reinforcement learning managing server; an average gradient receiving unit for receiving an average gradient obtained by calculating an average of the plurality of gradients reported from the federated reinforcement learning managing server; a learning parameter reporting unit for reporting a learning parameter to the federated reinforcement learning managing server; and a learning parameter receiving unit for receiving the first reported learning parameter from the federated reinforcement learning managing server, wherein the federated reinforcement learning unit is characterized in that the federated reinforcement learning is performed to complete the reinforcement learning in earlier stage than individual reinforcement learning, by performing continuously the reinforcement learning using the average of the received gradients, and by performing the reinforcement learning using the received learning parameter in case that the learning parameter are received under the state that corresponding reinforcement learning is not completed.

In addition, the gradient is the rate at which the reinforcement learning is performed in the process of performing the reinforcement learning, and is characterized in that a plurality of reinforcement learnings performed through the plurality of device controllers are proceeded at an average rate of the plurality of reinforcement learnings by sharing the gradient.

In addition, each of the plurality of device controllers further comprises a device control unit that controls the device using each of the generated learning models; and a device state information providing unit that provides the state information of each of the device controllers to the federated reinforcement learning managing server.

In addition, the federated reinforcement learning managing server comprises a gradient receiving unit configured to request and receive the gradient from the plurality of device controllers; a gradient sharing unit configured to transmit and share the average gradient obtained by the average of the received gradients to the plurality of device controllers; a learning parameter receiving unit configured to receive the learning parameter reported from the device controller in which the reinforcement learning has been completed using the shared gradient; and a learning parameter providing unit configured to provide and transfer the received learning parameter to at least more than one of the device controllers in which the reinforcement learning has not been completed.

In addition, the federated reinforcement learning managing server further comprises a device state information receiving unit configured to receive device state information resulting from controlling the corresponding devices in the plurality of device controllers, and configured to re-perform the federated reinforcement learning by transmitting the re-execution command for the federated reinforcement learning to the plurality of device controllers, in case that the received device state information is monitored, and the monitoring result is outside the preset threshold range.

Moreover, a method for controlling multiple devices through a federated reinforcement learning in accordance with another embodiment of the present disclosure, comprising: in a plurality of service controllers, individually performing the reinforcement learning to control each of the plurality of devices and reporting the gradient calculated in the process of the reinforcement learning according to a request of a federated reinforcement learning managing server to the federated reinforcement learning managing server; in the federated reinforcement learning managing server, sharing the averaged gradient by providing the averaged gradient calculated for the reported gradients to the plurality of device controllers; in the plurality of service controllers, continuing the reinforcement learning using the shared averaged gradient; in at least one of the plurality of service controllers, when the reinforcement learning using the averaged gradient is completed, reporting a learning parameter according to the completed result to the federated reinforcement learning managing server; in the federated reinforcement learning managing server, transferring the learning parameter by transmitting the first reported and received learning parameter to the at least one device controller for which the reinforcement learning is not completed; and in the at least one device controller, continuously performing the reinforcement learning by using the received learning parameter, wherein the method is characterized in that overall reinforcement learning is completed earlier than individually performed reinforcement leanings by performing the federated reinforcement learning in coalition with the reinforcement leanings through the sharing of the averaged gradient and the transferring of the learning parameter

In addition, the gradient is a rate at which the reinforcement learning is performed in the process of performing the reinforcement learning, and the method is characterized in that a plurality of reinforcement learnings performed through the plurality of device controllers are proceeded at an average rate of the plurality of reinforcement learnings by sharing the gradient.

In addition, a method for controlling multiple devices through the federated reinforcement learning, further comprises: in the plurality of service controllers, controlling the corresponding devices by corresponding learning model generated through the federated reinforcement learning; and in the plurality of service controllers, providing state information of the devices according to the result of controlling the devices to the federated reinforcement learning managing server, wherein the method is characterized in that the reinforcement learning is performed again in the plurality of device controllers in case that a re-execution command for the federated reinforcement learning is received from the federated reinforcement learning managing server according to a result of monitoring the state information.

In addition, a method for controlling multiple devices through the federated reinforcement learning, further comprises: in the federated reinforcement learning managing server, receiving state information of the devices resulting from controlling the devices from the plurality of device controllers, wherein the method is characterized in that the reinforcement learning is performed again by transmitting the re-execution command for the federated reinforcement learning to the plurality of device controllers in the federated reinforcement learning managing server in case that the received state information of the devices is monitored, and the monitoring result is out of a preset threshold range.

As described above, the system for controlling multiple devices and method thereof through the federated reinforcement learning in accordance of one embodiment of the present disclosure, are effective to enable the device controller to precisely and efficiently control the device through the learning model, which is generated for extracting an optimal control command according to the state information for each of the devices through the reinforcement learning for training the learning data generated for each of the devices, in each of device controllers for controlling the plurality of devices having similar or the same characteristics and purposes.

In addition, the present disclosure is effective to enable precise and efficient control of each device by using the learning model generated through the reinforcement learning as well as to complete the reinforcement learning quickly and accurately, through the federated reinforcement learning that performs a coalition of the reinforcement learning for each of device controllers, by performing a gradient sharing process of synchronizing the reinforcement learnings performed by each of the device controllers, averaging the gradients calculated in each of the reinforcement learning processes, and sharing the averaged gradients with each of the device controllers, and a learning parameter transfer process of transferring the learning parameter of a specific device controller to which the reinforcement learning is first completed to the learning parameter of other device controllers.

In more detail, the present disclosure can adapt to precise control of multiple devices (i.e., robots in smart factory) for accelerating the training rate for multiple devices with similar dynamic characteristics, does not have to separately find optimal deep learning model parameters for each device, and thus provides the effectives to reinforce the generalization of the learning model as well as save time, energy and cost.

### BRIEF DESCRIPTION OF THE DRAWINGS

FIG. 1 is a conceptual diagram illustrating a system and method for controlling multiple devices through a federated reinforcement learning according to an embodiment of the present disclosure.

FIG. 2 is a diagram illustrating a reinforcement learning process performed in a device controller through federated reinforcement learning according to an embodiment of the present disclosure.

FIG. 3 is a diagram illustrating a process of performing a federated reinforcement learning according to an embodiment of the present disclosure.

FIG. 4 is a block diagram showing a configuration of a device controller through a federated reinforcement learning according to an embodiment of the present disclosure.

FIG. 5 is a block diagram showing a configuration of a federated reinforcement learning managing server according to an embodiment of the present disclosure.

FIG. 6 is a flowchart illustrating a procedure for controlling multiple devices through a federated reinforcement learning according to an embodiment of the present disclosure.

### DESCRIPTION OF THE PREFERRED EMBODIMENTS

Hereinafter, a preferred embodiment of a system for multiple devices and method thereof through a federated reinforcement learning according to the present disclosure will be described in detail with reference to the accompanying drawings. The same reference numerals in each drawing indicate the same components. In addition, specific structural or functional descriptions of the embodiments of the present disclosure are exemplified only for the purpose of describing the embodiments according to the present disclosure, and unless otherwise defined, all of the technical or scientific terms used herein have the same meaning as commonly understood by one of ordinary skill in the art to which the present disclosure belongs. Terms as defined in a commonly used dictionary should be interpreted as having a meaning consistent with the meaning of the related technology, and unless explicitly defined in the specification, it is preferable not to be interpreted in an ideal or excessively formal sense.

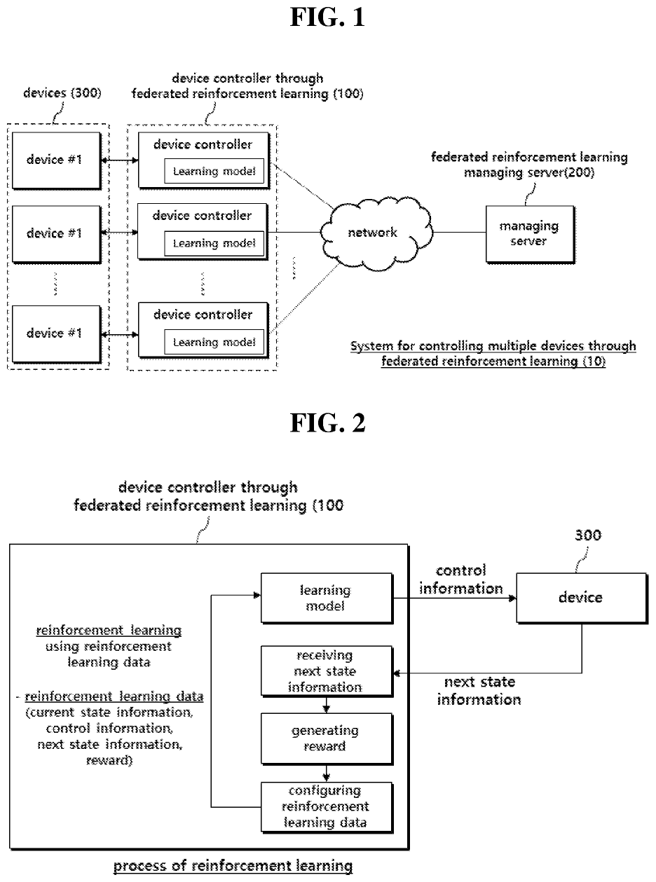

FIG. 1 is a conceptual diagram illustrating a system and method for controlling multiple devices through a federated reinforcement learning according to an embodiment of the present disclosure.

As shown in FIG. 1, the system for multiple devices 10 through a reinforcement learning according to an embodiment of the present disclosure, is for automatically controlling a plurality of devices 300, comprises the plurality of devices 300, a plurality of device controllers 100 respectively corresponding to the plurality of devices 300, and a managing server 200 that manages the plurality of devices 300 and the plurality of device controllers 100.

The plurality of devices 300, refer to a plurality of devices having similar characteristics and used to achieve the same purpose, like an unmanned transportation means for transporting specific objects (e.g., robots, robot arms, drones, etc.), a manufacturing means for manufacturing specific objects, etc.

In addition, each of the plurality of devices 300 comprises a plurality of sensors (not shown) for collecting state information on a control state according to the control for each of the device controllers 100. The sensor performs a function of collecting state information of a device according to the control and providing it to the device controller 100.

In addition, the device controller 100, while having a learning model for controlling the device 300, performs a reinforcement learning on the learning model, so that a final learning model is created for precise control according to function or purpose of use of the device controller 100.

The device controller 100 creates a reward for the purpose of performing the reinforcement learning, by extracting control information for controlling the device 300 through the learning model and transmitting the control information to the device 300, and by receiving next state information of the device 300 controlled according to the control information from the device 300.

Thereafter, the device controller 100 configures a reinforcement learning data including the reward and performs the reinforcement learning for the learning model using the configured reinforcement learning data. By repeatedly performing such processes, a corresponding learning model is advanced, thereby generating a final learning model that enables precise control according to the function or purpose of use of the device 300.

Meanwhile, the configured reinforcement learning data includes current state information of the device 300, control information according to the current state information, next state information that controls the device according to the control information (i.e., means state information transferred from the previous state information according to the control information), and a reward calculated whether the device 300 has operated well within a preset threshold range or not, when the device 300 is changed to the next state information according to the control information. In this case, the reward means a compensation value for the next state information of the device 300 controlled based on the control information.

In addition, the current state information and the next state information, include state information (e.g., angle, angular velocity) of an actuator (e.g., a motor) that is an operational subject of the device 300, and location information of the device 300 changed according to the control information. That is, the device state information including the current state information and the next state information can be variously set according to a unique function or type of the device 300. Likewise, the control information can be also variously set according to the function or type of the device 300.

As an example, when the plurality of devices 300 are applied to a smart factory and are an unmanned transfer means that performs a function of transferring a specific product, the device state information can include an angle, an angular velocity or location information of the corresponding unmanned transfer means, and the control information can include a control command for driving the actuator or moving the unmanned transfer means based on the current state information of the unmanned transfer means. In addition, the reward is that in case that the next state information, which is the result of control according to the control information, is generated according to a preset threshold range, and is within the threshold range, it is determined that the device 300 has properly operated, and a compensation value (e.g., +1) set in advance is applied to the next state information, and if it is out of the threshold range, it is determined that the device 300 has not properly operated and a preset compensation value (e.g. −1) is applied to the next state information.

In this case, when the compensation value is out of the threshold range, the reward can be applied differently according to a ratio close to the threshold range. That is, the larger the deviation of the threshold range is, the greater the magnitude of the compensation value (i.e., negative value) can be increased, and can be applied differently depending on the degree of deviation.

Meanwhile, the reinforcement learning data are configured for each of the device controllers 100, configured in real time by controlling the device 300 and used for the reinforcement learning, or the reinforcement learning data can be configured in advance by accumulating and storing the result generated by directly controlling the device 300 through the device controller 100 by an administrator of the system for controlling multiple devices 10 through the federated reinforcement learning.

In addition, the reinforcement learning is performed as a federated reinforcement learning in which each of the reinforcement learnings performed for each of the device controller 100 are federated, and the federated reinforcement learning comprises a gradient sharing process for sharing gradients calculated in a process of reinforcement learning individually performed for each of the device controllers 100, and a learning parameter transfer process applied to the reinforcement learning for the learning model by transmitting the learning parameter of the learning model of a specific device controller 100 on which the reinforcement learning is completed to each of the other device controllers 100 for which each of the reinforcement learnings is not completed,

The gradient means the rate at which the reinforcement learning is performed in the process of reinforcement learning that minimizes errors between the control state of the device 300 controlled through the control information that is the output of the learning model and the control state of the device 300 that the actual administrator wants

In addition, the gradient sharing process averages the gradients calculated in the process of reinforcement learning performed for each of the device controllers 100 and shares the averaged gradient with each of the device controllers 100, so that the averaged gradient is to be used for each of the reinforcement learnings, and thus a plurality of reinforcement learnings performed by the plurality of device controllers 100 are performed through the gradient sharing process at an average rate among the reinforcement learnings.

In addition, the learning parameter transfer process transfers a learning parameter by providing the learning parameter of the learning model in which the reinforcement learning is completed to the other device controllers 100 for which the reinforcement learning is not completed, in case that the reinforcement learning is completed in the specific device controller 100 as a result of continuing the reinforcement learning using the shared gradient (i.e., the averaged gradient), and allows the rest of reinforcement learning to proceed in the other device controllers 100 in which the reinforcement learning is not completed, by setting the provided learning parameter as the learning parameter of a learning model in which the reinforcement learning is in progress. Through the above processes, the entire reinforcement learning performed for each of the device controllers 100 can be accurately and early completed as compared with individually processed reinforcement learnings.

In addition, the federated reinforcement learning managing server 200 performs a function of controlling to perform a federated reinforcement learning which federates the reinforcement learnings individually performed in each of the device controllers 100, through the gradient sharing process and the learning parameter transfer process.

To this end, the federated reinforcement learning managing server 200 allows the gradient to be shared by synchronizing the reinforcement learnings performed for each of the device controllers 100, by requesting and receiving the gradient for each of the device controllers 100 calculated in each of the reinforcement learning processes, by calculating average of a received plurality of gradients and providing the average of the calculated gradients to each of the device controllers 100.

In addition, when a reinforcement learning is completed and learning parameter for the learning model as a result of completing the reinforcement learning are received, in the device controllers 100 performing the reinforcement learning using the shared gradient, the federated reinforcement learning managing server 200 performs, by providing and transferring the received learning parameter to the other device controllers 100 for which the reinforcement learning is not completed, the remaining reinforcement learning using the provided learning parameter.

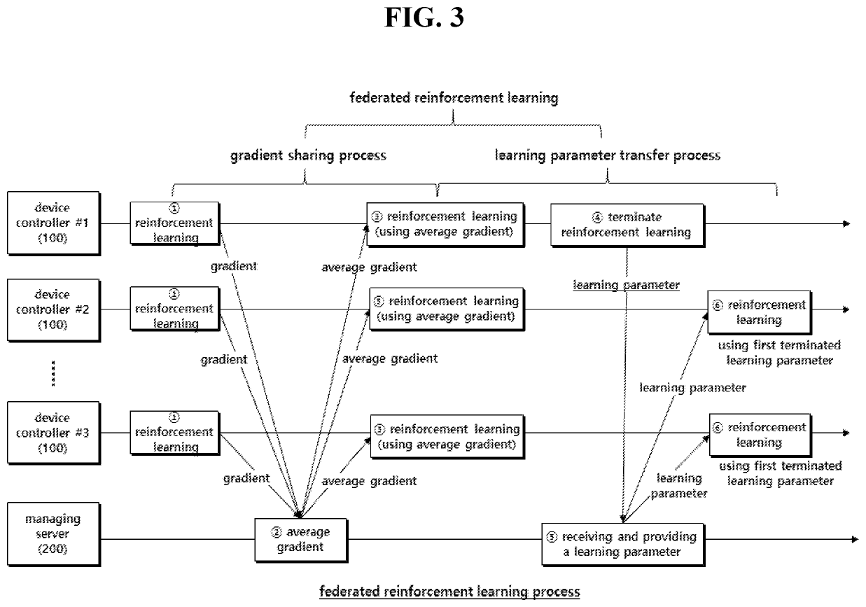

Meanwhile, hereinafter the reinforcement learning individually performed for each of the device controllers 100 will be described with reference to FIG. 2, and the federated reinforcement learning will be described in detail with reference to FIG. 3.

In addition, the device controller 100 performs a function of individually controlling the device according to the function or purpose of use of each of the devices 300 by using a learning model generated according to the result of performing the federated reinforcement learning, and provides device state information including current state information of the device 300 according to a result after the device is controlled and previous state information before the device is controlled, to the federated reinforcement learning managing server 200.

In addition, the federated reinforcement learning managing server 200 accumulates and stores the device state information, and monitors whether the device 300 operates well within a preset threshold range or not.

Thereafter, as a result of the monitoring, when the device state information is not accurately transferred within a preset threshold range, the federated learning process can be re-performed.

That is, the federated reinforcement learning managing server 200 allows the device controller 100 to continuously and precisely control the device 300 by adapting to the aging or the surrounding environment of the device 300, by re-performing the federated learning process in case that the device 300 is not precisely controlled due to aging according to the long term use of the device 300 or the change of the surrounding environment of the device 300.

As described above, the system for controlling multiple devices 10 through the federated reinforcement learning in accordance with the present disclosure, enables the entire reinforcement learning performed by a plurality of device controllers 100 to be accurately and quickly completed, as well as a plurality of devices 300 to be precisely controlled, by associating with the reinforcement learnings performed by the plurality of device controllers 100 for individually controlling the plurality of devices 300 so as to perform a federated reinforcement learning for the reinforcement learnings.

FIG. 2 is a diagram illustrating a reinforcement learning process performed in a device controller through federated reinforcement learning according to an embodiment of the present disclosure.

As shown in FIG. 2, a plurality of device controllers 100 according to an embodiment of the present disclosure finally generate a learning model for precisely controlling the device 300 by performing a federated reinforcement learning which combines a plurality of reinforcement learnings, wherein the reinforcement learnings are performed on a learning model to individually control the device 300 and individually performed by each of the plurality of device controllers 100 under the control of the federated reinforcement learning managing server 200.

The device controller 100 performs a reinforcement learning on a learning model that outputs a control command for controlling the device 300.

In order to perform the reinforcement learning, the device controller 100 inputs the current state information of the device 300 into the learning model, and outputs control information for controlling the device 300, and controls the device 300 based on the output control information.

Wherein, the device controller 100 outputs control information by inputting current state information to a learning model, wherein the current state information is an initial state in which the device 300 is initialized or received state information received by requesting state information to the device 300 when the reinforcement learning is performed for the first time.

Next, the device controller 100 receives next state information and generates a reward for the received next state information, where the next state is the state controlled based on the control information from the device 300.

That is, the device controller 100 generates a reward for the received next state information of the device 300, so that reinforcement learning data including the generated reward can be configured.

In addition, the device control device 100, in case that a reward for the next state information of the device 300 is generated, configures reinforcement learning data comprising control information which is extracted based on current state information and current state information of the device 300, next state information of the device 300 controlled according to the control information, and a reward generated for the next state information.

Thereafter, the device controller 100 performs a reinforcement learning on a learning model by using the configured reinforcement learning data, and repeatedly performs the reinforcement learning, and allows the device 300 to be precisely controlled through the learning model.

On the other hand, the transmission and reception of control information and the next state information of the device 300 according to the control information are performed through a MQTT (Message Queue Telemetry Transport) communication method that enables high-speed communication even in a low bandwidth and low power consumption environments. However, the present disclosure is not limited thereto, and can be implemented to transmit/receive control information and following state information through various wired/wireless communication methods such as 5G and Ethernet.

The reinforcement learning for the learning model is performed by using the configured reinforcement learning data, the input of the learning model finally generated through the federated reinforcement learning becomes the current state information of the device 300, and the output becomes control information for transitioning from the current state to the next state of the device 300.

In addition, the reinforcement learning is performed to extract control information for transferring from the current state to the next state of the device 300. In more detail, the reinforcement learning is performed to extract a control command for the next state information having a high overall reward until the final object (i.e., transporting a specific object to a specific location) according to the function of the device 300 is achieved.

That is, the device controller 100 performs a reinforcement learning on a learning model not simply to extract control information having a high reward for the next state information, but extract control information having high overall reward up to the state information according to the final purpose.

FIG. 3 is a diagram illustrating a process of performing a federated reinforcement learning according to an embodiment of the present disclosure.

As shown in FIG. 3, the process of performing the reinforcement learning according to an embodiment of the present disclosure, first, individually performs a reinforcement learning for a learning model that extracts control information in order to control the device 300 to be controlled, according to the control of the federated reinforcement learning managing server 200 in a plurality of device controllers (100) (\textcircled{1}).

The federated reinforcement learning managing server 200 synchronizes the reinforcement learnings performed in the device controllers 100, allows each of the device controllers 100 to perform the federated reinforcement learning combined with each of the reinforcement learnings, so that the overall reinforcement learning is completed early, and performs a function of generating a learning model that precisely controls the devices 300 as described above.

In addition, in case of that the plurality of device controllers 100 receive a request command of a gradient from the federated reinforcement learning managing server 200 while performing the reinforcement learning, each of the device controllers 100 calculates the gradient in the process of the reinforcement learning performed so far and reports the gradient to the federated reinforcement learning managing server 200.

Next, the federated reinforcement learning managing server 200 averages each of the gradients received from the plurality of device controllers 100 (\textcircled{2})), and provides the averaged gradient to the federated reinforcement learning managing server 200, the plurality of device controllers 100 perform a gradient sharing process of sharing the gradient (i.e., sharing the averaged gradient), and each of the device controllers 100 continues the reinforcement learning using the shared gradient.

Next, in case of receiving the averaged gradient, each of the device controllers 100 continues the reinforcement learning using the received averaged gradient (\textcircled{3})).

Here, the gradient means the speed at which the reinforcement learning is performed, the speed of reinforcement learning performed by each device controllers 100 can vary depending on the quality of reinforcement learning data individually configured by each of the device controllers 100 or the performance of a learning model, and thus a plurality of reinforcement learnings performed by the device controllers 100 are performed at an average speed through the gradient sharing process.

Thereafter, the plurality of device controllers 100, as a result of continuing the reinforcement learning using the average gradient, in the case that the learning model achieves the accuracy (i.e., the optimal solution) so that the learning model is capable of controlling precisely according to the function and purpose of the device 300, the reinforcement learning is completed (\textcircled{4}), and the learning parameter for the learning model that completes the reinforcement learning are reported to the federated reinforcement learning managing server 300.

In addition, the federated reinforcement learning managing server 300 receives a learning parameter from the device controller 100 which completes the reinforcement learning, performs a learning parameter transfer process that transmits the learning parameter to the device controllers 100 that do not complete the reinforcement learning (C)), performs the reinforcement learning by using the learning parameter of the completed reinforcement learning in the device controllers 100 that do not complete the reinforcement learning, and continues the corresponding reinforcement learning until the accuracy requirement is achieved.

The device controller 100 that does not complete the reinforcement learning through the learning parameter transfer process has effective to perform the reinforcement learning by using not only its own reinforcement learning data, but also the reinforcement learning data configured by the device controller 100 that completes the reinforcement learning, and thus the accuracy can be achieved more quickly.

That is, the present disclosure relates to early achieving the overall reinforcement learning, which is performed in the plurality of device controllers by performing the federated reinforcement learning for the reinforcement learnings with associating reinforcement learnings individually performed by a plurality of device controllers 100, through the gradient sharing process and the learning parameter transfer process, and finally generates a learning model capable of precisely controlling the devices 300.

Meanwhile, the gradient sharing process and the learning parameter transfer process are sequentially performed and can be performed multiple times. Even when the device controller 100 in which the reinforcement learning is terminated exists, the federated reinforcement learning combining the reinforcement learning again, can be performed in the device controllers 100 in which the corresponding reinforcement learning is not completed.

In each device controller, the gradients

$$\frac{d L ( {θ}_{1} )}{d {θ}_{1}} to \frac{d L ( {θ}_{n} )}{d {θ}_{n}} in {θ}_{1} ← {θ}_{1} - α \frac{d L ( {θ}_{1} )}{d {θ}_{1}} to {θ}_{n} ← {θ}_{n} - α \frac{d L ( {θ}_{n} )}{d {θ}_{n}}$$

are averaged as

$$( \frac{{\sum }_{i = 1}^{n} \frac{d L ( {θ}_{i} )}{d {θ}_{i}}}{n} = G )$$

and then the average gradient is shared to each of the devices as θ₁←θ₁−αG to θₙ←θₙ−αG.

The learning parameter, as an example, θ₁ in

$${θ}_{1} ← {θ}_{1} - α \frac{d L ( {θ}_{1} )}{d {θ}_{1}}$$

for each device in corresponding device controller is transferred to other device controllers

$$( i . e . , {θ}_{2} ← {θ}_{1} - α \frac{d L ( {θ}_{2} )}{d {θ}_{2}} to {θ}_{n} ← {θ}_{1} - α \frac{d L ( {θ}_{n} )}{d {θ}_{n}} )$$

through the federated reinforcement learning managing server 200.

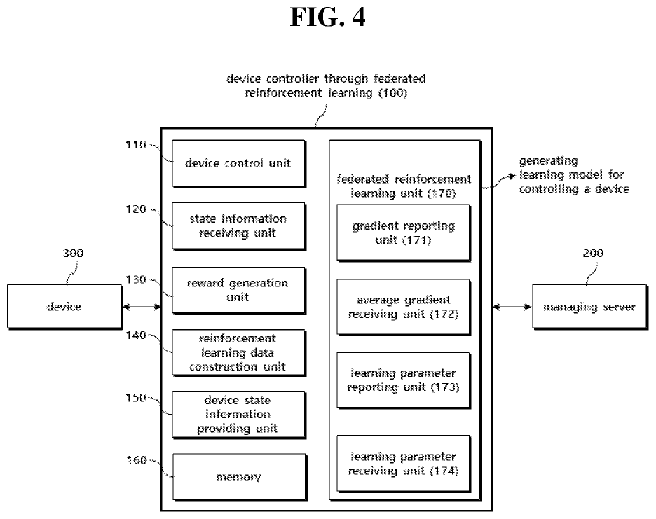

FIG. 4 is a block diagram showing a configuration of a device controller through a federated reinforcement learning according to an embodiment of the present disclosure.

As shown in FIG. 4, the device controller 100 through a federated reinforcement learning according to an embodiment of the present disclosure comprises: a device control unit 110 that transmits and controls control information to a device 300 connected to the device controller 100, a state information receiving unit 120 for receiving state information according to the control result from the device 300, a reward generation unit 130 for generating a reward according to the received state information, a reinforcement learning data construction unit 140 for configuring reinforcement learning data of a learning model for controlling the device based on the received state information and the generated reward, a device state information providing unit 150, a memory 160 and a federated reinforcement learning unit 170 that finally generates a learning model for precisely controlling the device by performing a federated reinforcement learning by confederating the reinforcement learning for the learning model and the reinforcement learnings performed by at least one or more other device controllers 100.

The device control unit 110 extracts control information for controlling the device 300 by inputting the current state information of the device 300 into the learning model in order to perform reinforcement learning on the learning model, or extracts control information for controlling the device 300 by using the learning model finally generated through the federated reinforcement learning unit 170, and thus performs a function of controlling the device 300.

In addition, the state information receiving unit 120 performs a function of receiving next state information of the device 300 transitioned from a current state to a next state according to the control information.

Each device 300 to be controlled by each of the plurality of device controllers 100 refers to a device having similar characteristics and the same purpose, such as an unmanned transport means for transporting a specific object, and the state information, as described above, comprises the position information of the device 300, an angle of an actuator for driving the device 300, an angular velocity, and the like.

In addition, the reward generation unit 130 performs a function of generating a reward for the next state information of the state of the device 300 that is transferred based on the control information.

The reward is generated by calculating the reward for the next state information based on a preset threshold range based on the received next state information on the device 300.

In addition, the reward is generated as a positive compensation value previously set in case that the next state information of the received device 300 is operated within the threshold range, and the reward is differentially generated as a negative compensation value set in advance according to the proximity of the threshold range in case that the reward is operated outside the threshold range.

In addition, the reinforcement learning data construction unit 140 performs a function of constructing the reinforcement learning data for performing the reinforcement learning of the learning model.

The reinforcement learning data comprises current state information of the device 300, control information extracted based on the current state information, next state information received from the device 300 controlled based on the control information, and the reward created according to the next state information.

In addition, the reinforcement learning data construction unit 140 provides the configured reinforcement learning data to the federated reinforcement learning unit 170 so that the reinforcement learning for the learning model can be continuously performed.

In addition, the federated reinforcement learning unit 170 basically performs the reinforcement learning on the learning model based on the configured reinforcement learning data, and the federated reinforcement learning in coalition with the reinforcement learnings performed by at least more than one of the other device controllers 100, and thus performs a function of finally generating a learning model that enables precise control of the device 300 by completing reinforcement learning as early as possible for the learning model.

Meanwhile, the federated reinforcement learning was described with reference to FIG. 3, as performed by sharing a gradient for reinforcement learning performed by a plurality of device controllers 100 and transferring a learning parameter, and thus further detailed description is omitted.

In addition, the federated reinforcement learning unit 170 comprises a gradient reporting unit 171 that calculates the gradient in the reinforcement learning process and reports the gradient to the federated reinforcement learning managing server 200, an average gradient receiving unit 172 for receiving an average gradient from the federated reinforcement learning managing server 200, a learning parameter reporting unit 173 that reports a learning parameter according to the completed result in case that the reinforcement learning is completed, and a learning parameter receiving unit 174 for receiving a learning parameter from the federated reinforced learning managing server 300.

The gradient reporting unit 171 performs functions of calculating the gradient in the performed reinforcement learning process and reporting the calculated gradient to the federated reinforcement learning managing server 200, in case that a gradient request command is received from the federated reinforced learning managing server 200 while reinforcement learning is being performed on the learning model through the federated reinforced learning unit 170.

In addition, the average gradient receiving unit 172 performs a function of receiving the average gradient calculated from the federated reinforcement learning managing server 200.

Wherein, the average gradient means an average value for a plurality of gradients reported by the plurality of device controllers 100, and the federated reinforcement learning managing server 100 provides the average gradient to the plurality of device controllers 100 so that the average gradient can be shared by the plurality of device controllers 100.

In addition, the federated reinforcement learning unit 170 continues the reinforcement learning using the received average gradient, in case that the average gradient is received from the federated reinforcement learning managing server 200. This allows the overall reinforcement learning performed by each of the plurality of device controllers 100 to proceed at an average speed among a plurality of the reinforcement learnings.

In addition, the learning parameter reporting unit 173 reports a learning parameter for the learning model on which the reinforcement learning is completed to the combined reinforcement learning managing server 200, in case that the reinforcement learning using the average gradient is completed.

In addition, the learning parameter receiving unit 174 performs a function of receiving a learning parameter for which the reinforcement learning is completed in a specific device controller 100 from the federated reinforcement learning managing server 200.

Wherein, the learning parameter in which reinforcement learning is completed in the specific device controller 100 mean the learning parameter in which the reinforcement learning is first completed in any one of the plurality of device controllers 100, and the learning parameter are received in case that the reinforcement learning for the learning model is not terminated through the federated reinforcement learning unit 170.

That is, the learning parameter received through the learning parameter receiving unit 174 is the learning parameter first reported to the federated reinforcement learning managing server 200, and the federated reinforcement learning managing server 200 receives a learning parameter in which the machine learning is completed in at least one of a plurality of device controllers 100, and transmits the learning parameter to the device controllers 100 that the reinforcement learning is not completed, and thus the learning parameter are transferred to the device controllers 100 and the device controllers 100 continue the corresponding reinforcement learnings using the transferred learning parameter.

In addition, the federated reinforcement learning unit 170 sets the learning parameter of the learning model with the received learning parameter, in case that the learning parameter are received at the state that the reinforcement learning using the average gradient is not terminated, and continue the reinforcement learning on the learning model. And thus, the federated reinforcement learning unit 170 finally generates the learning model that enables precise control of the device 300.

Meanwhile, the reinforcement learning is preferably performed using a DQN (Deep Q-Network) based on a CNN (Convolutional Neural Network) optimized for reinforcement learning, but the reinforcement learning can be performed through various machine learning networks such as an ANN (Artificial Neural Network).

In addition, the device controller 110 performs a function of precisely controlling the device 300 according to a function or purpose of use of the device 300 based on the generated learning model, and the device state information providing unit 150 transmits the state information of the controlled device 300 to the federated reinforcement learning managing server 200, so that it is possible to monitor the state in which the device 300 is substantially controlled.

Wherein, the device state information includes the current state information before controlling the device 300, control information extracted based on the current state information, and next state information of the device 300 controlled according to the control information.

In addition, the federated reinforcement learning managing server 200 enables the federated reinforced learning to be re-performed in case that the device 300 cannot be accurately controlled according to the monitoring result, so that the device controller 100 can precisely control the device 300 by adapting to the aging of the device 300 or the surrounding environment of the device 300.

In addition, the memory 160 stores the learning model and the reinforcement learning data, and a function to storing information related for the operation of the device controllers 100.

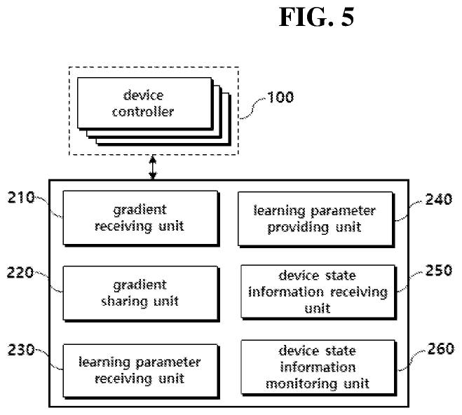

FIG. 5 is a block diagram showing a configuration of a federated reinforcement learning managing server according to an embodiment of the present disclosure.

As shown in FIG. 5, the federated reinforcement learning managing server 200 according to an embodiment of the present disclosure comprises a gradient receiving unit 210 for receiving the gradient reported from a plurality of device controllers 100, a gradient sharing unit 220 that averages the received gradients and shares the averaged gradient with the plurality of device controllers 100, a learning parameter receiving unit 230 that receives the learning parameter reported from the plurality of device controllers 100, a learning parameter providing unit 240 that provides the received learning parameter to the device controller 100 for which the reinforcement learning is not completed, a device state information receiving unit 250 for receiving the device state information which is a result of controlling the device 300 for each of the device controllers 100 through a learning model generated as a result of the reinforcement learning, and a device state information monitoring unit 260 that monitors a control status of the device 300 based on the received device state information.

In addition, the gradient receiving unit 210 performs a function of requesting and receiving a gradient calculated in the reinforcement learning to/from a plurality of device controllers 100 performing the reinforcement learning.

In addition, the gradient sharing unit 220 produces an average gradient by calculating the average of a plurality of gradients received from the plurality of device controllers 100.

In addition, the gradient sharing unit 220 performs a process of sharing the gradient to the plurality of device controllers 100 by providing the calculated average gradient to the plurality of device controllers 100.

That is, the gradient sharing process of sharing the gradient is performed by providing the average gradient obtained by the average of the plurality of gradients to the plurality of device controllers 100.

In addition, the learning parameter receiving unit 230 performs a function of receiving a learning parameter upon completion of a reinforcement learning from the at least one device controller 100 on which the reinforcement learning is completed among the plurality of device controllers 100 continuously performing the reinforcement leanings by using the shared gradient.

In addition, the learning parameter providing unit 240 provides the received learning parameter to at least one device controller 100 in which the reinforcement learning is not completed, and performs a learning parameter transfer process of transferring the received learning parameter to the at least more than one on the device controllers 100.

That is, the federated reinforcement learning managing server 200 associates the reinforcement leanings performed for each device controller 100 through the gradient sharing process and the learning parameter transfer process, so that the federated reinforcement learning for the reinforcement learnings should be performed in the device controllers 100, and thus enabling the entire reinforcement learning performed for each of the device controllers 100 to be accurately and early completed, so that the actual device 300 can be precisely controlled.

In addition, the device state information receiving unit 250 performs a function of receiving device state information controlling each of the devices 300 based on the learning model generated for each device controller 100 according to the result of performing the federated reinforcement learning.

In addition, the device state information monitoring unit 260 performs a function of monitoring a control state controlling the device 300 based on the received device state information, and a function of re-performing the federated reinforcement learning in case that the device 300 is not accurately controlled according to the monitoring result.

Wherein, the device state information monitoring unit 260 performs monitoring the device state information, and decides whether the transition is occurred or not according to the preset threshold range when transitioning from the current state information of the device 300 to the next state information according to the control information, so that whether the reinforcement learning is re-performed or not should be determined.

That is, the device state information monitoring unit 260 makes the federated reinforcement learning re-performed when the next state information exceeds the threshold range, and adapts to aging or changes in surrounding environment according to the use of the device 300, and thus the device 300 can be continuously and precisely controlled.

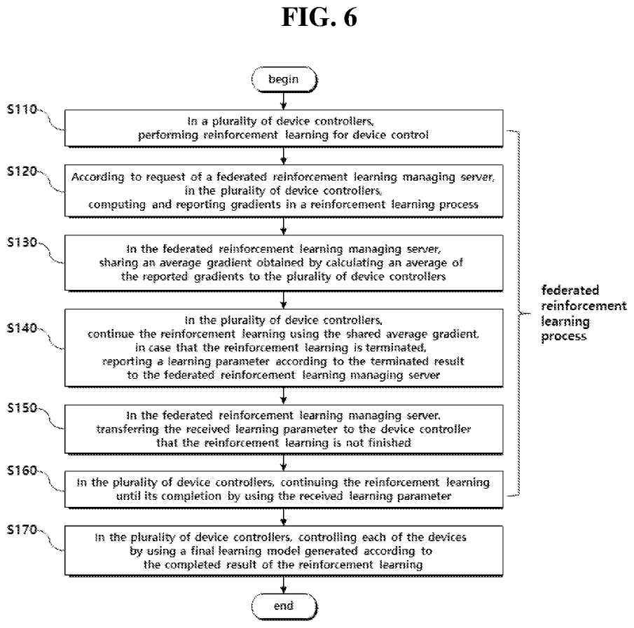

FIG. 6 is a flowchart illustrating a procedure for controlling multiple devices through a federated reinforcement learning according to an embodiment of the present disclosure.

As shown in FIG. 6, the procedure for controlling multiple devices through federated reinforcement learning according to an embodiment of the present disclosure comprises first to configure performing the reinforcement learnings to control each of the device connected to the corresponding device controller 100 in the plurality of device controllers 100 (S110).

The process of performing the reinforcement learning is performed for each learning model prepared in advance, and since the process of performing the reinforcement learning has been described with reference to FIG. 2, the detailed description will be omitted.

Next, when the device controller 100 receives a gradient request from the federated reinforcement learning managing server 200, the device controller 100 calculates a gradient in the reinforcement learning process and reports the calculated gradient to the federated reinforcement learning managing server 200 (S120).

The gradient means a speed at which the reinforcement learning is performed for each device controller 100.

Next, the federated reinforcement learning managing server 200 calculates an average gradient obtained by calculating an average of the reported plurality of gradients, and provides the calculated average gradient to the plurality of device controllers 100, so that the average gradient is shared (S130).

That is, the federated reinforcement learning managing server 200 performs a gradient sharing process for sharing the average gradient, so that the reinforcement learning performed by the device controller 100 is performed at an average speed.

Next, the plurality of device controllers 100 continue the reinforcement learning using the average gradient shared through the federated reinforcement learning managing server 200, and when the reinforcement learning is completed, reports a learning parameter according to the completed result to the federated reinforcement learning managing server 200 (S140).

That is, the plurality of device controllers 100 continue the reinforcement leanings by using the shared average gradient, and as a result of the continuation, when the learning model that is the target of the reinforcement learning arrives at an optimum state (i.e., accuracy enough to precisely control the device) for precisely controlling the device 300, the corresponding reinforcement learning is completed, and then transmits the learning parameter of the learning model for which the reinforcement learning is completed to the federated reinforcement learning managing server 200.

Next, the federated reinforcement learning managing server 200 transmits the received learning parameter to the device controller 100 in which the reinforcement learning is not completed (S150).

That is, the federated reinforcement learning managing server 200 receives a learning parameter from at least one device controller 100 that early terminates reinforcement learning using the average gradient, and performs a learning parameter transfer process which transfers the received learning parameter to at least more than one of the device controllers 100 that are not completed the reinforcement learnings.

Next, the plurality of device controllers 100 continue the reinforcement learnings by using the learning parameter received from the federated reinforcement learning managing server 200 and terminates corresponding reinforcement learning when the accuracy for the learning model is achieved.

As described above, the present disclosure provides to perform a federated reinforcement learning for the reinforcement learnings in coalition with the reinforcement learnings that are individually performed in a plurality of device controllers 100 through the processes S110 to S160, so that at the same times a plurality of reinforcement learnings performed by the plurality of device controllers 100 are early terminated and the learning models having high accuracy for controlling the device 100 are created.

Next, the plurality of device controllers 100 perform a process of precisely controlling the device 300 using the finally generated learning model, according to the completion result by proceeding with the reinforcement learning through the federated reinforcement learning (S170).

A process of controlling the device 300 is performed by repeating the processes of inputting the current state information of the device 300 to the generated learning model according to the function or purpose of use of the device 300, extracting control information for the current state information through the learning model, and controlling the device 300 according to the extracted control information.

As explained above, a system and method for controlling multiple devices through federated reinforcement learning according to an embodiment of the present disclosure, in case of performing reinforcement learning on a learning model for controlling a device in a plurality of device controllers, associate the reinforcement learnings performed by the plurality of device controllers, and perform the federated reinforcement learning for the reinforcement learnings, so that there is an effect of generating the learning model that enables precise control of the device by early completing a plurality of reinforcement learnings performed by the plurality of device controllers.

In the above description, a preferred embodiment according to the present disclosure has was mainly described, but the technical idea of the present disclosure is not limited thereto, each component of the present disclosure can be changed or modified within the technical scope of the present disclosure in order to achieve the same object and effect.

In addition, although the preferred embodiments of the present disclosure are illustrated and described above, the present disclosure is not limited to the specific embodiments described above, of course various modifications can be implemented by those of ordinary skill in the technical field to which the present disclosure pertains without departing from the gist of the present disclosure claimed in the claims, and these modified implementations should not be individually understood from the technical idea or perspective of the present disclosure.

What is claimed is:

1. A system for controlling multiple devices through a federated reinforcement learning, comprises:
a plurality of device controllers configured to perform each of reinforcement learnings to control each of a plurality of devices and report gradients calculated in a process of the reinforcement learnings and a learning parameter according to completion of each of the reinforcement learnings to a federated reinforcement learning managing server;
and the federated reinforcement learning managing server configured to average the reported gradients, share the average gradient with the plurality of device controllers, and transfer the reported learning parameter to at least more than one of the devices in which corresponding reinforcement learning is not completed,
wherein the system is characterized in that the overall reinforcement learning is completed earlier than individually processed reinforcement learnings by performing the federated reinforcement learning in coalition with the reinforcement learnings through the sharing of the average gradient and the transferring of the learning parameter.

2. The system of claim 1, wherein the plurality of device controllers further configured to comprise a federated reinforcement learning unit that generates a learning model for controlling the device through the federated reinforcement learning,
wherein the federated reinforcement learning unit configured to comprise:
a gradient reporting unit configured to calculate the gradient for the reinforcement learning currently being performed according to the request of the federated reinforcement learning managing server and report the calculated gradient to the federated reinforcement learning managing server;
an average gradient receiving unit configured to receive the average gradient obtained by calculating average of the plurality of gradients reported from the federated reinforcement learning managing server;
a learning parameter reporting unit configured to report the learning parameter to the federated reinforcement learning managing server; and
a learning parameter receiving unit configured to receive the first reported learning parameter from the federated reinforcement learning managing server,
wherein the federated reinforcement learning unit is characterized in that the federated reinforcement learning is performed to complete the reinforcement learning in earlier stage than individually processed reinforcement learnings, by performing continuously the reinforcement learnings by using the received average gradient and the received learning parameter, in case that the learning parameter are received under the state that corresponding reinforcement learning is not completed.

3. The system of claim 1, wherein the gradient is the rate at which the reinforcement learning is performed in the process of performing the reinforcement learning, and is characterized in that a plurality of reinforcement learnings performed through the plurality of device controllers are proceeded at average rate of the plurality of reinforcement learnings by sharing the gradient.

4. The system of claim 2, wherein each of the plurality of device controllers further configured to comprise:
a device control unit configured to control the device using the generated learning model; and
a device state information providing unit configured to provide a state information of each of the device controllers to the federated reinforcement learning managing server.

5. The system of claim 1, wherein the federated reinforcement learning managing server further configured to comprise:
a gradient receiving unit configured to request and receive the gradient from the plurality of device controllers;
a gradient sharing unit configured to transmit and share the average gradient obtained by the average of the received gradients to the plurality of device controllers;
a learning parameter receiving unit configured to receive the learning parameter reported from the device controller in which the reinforcement learning is completed using the shared gradient; and
a learning parameter providing unit configured to provide and transfer the received learning parameter to at least more than one of the device controllers in which the reinforcement learning is not completed.

6. The system of claim 5, wherein the federated reinforcement learning managing server further configured to comprise:
a device state information receiving unit configured to receive device state information resulting from controlling the corresponding devices from the plurality of device controllers; and
wherein the federated reinforcement learning managing server is configured to re-perform the federated reinforcement learning by transmitting the re-execution command for the federated reinforcement learning to the plurality of device controllers, in case that the received state information is monitored and the monitoring result is outside the preset threshold range.

7. A method for controlling multiple devices through a federated reinforcement learning comprises:
in a plurality of device controllers, individually performing each of the reinforcement learnings to control each of the plurality of devices and reporting the gradient calculated in the process of the reinforcement learning according to a request of a federated reinforcement learning managing server to the federated reinforcement learning managing server;
in the federated reinforcement learning managing server, sharing the average gradient by providing the average gradient calculated for a plurality of the gradients reported from the plurality of device controllers;
in the plurality of service controllers, continuing the reinforcement learning using the shared averaged gradient;
in at least one of the plurality of service controllers, when the reinforcement learning using the average gradient is completed, reporting a learning parameter according to the completed result to the federated reinforcement learning managing server;
in the federated reinforcement learning managing server, transferring the learning parameter by transmitting the first reported and received learning parameter to the at least one device controller for which the reinforcement learning is not completed; and
in the at least one device controller, continuously performing the reinforcement learning by using the received learning parameter,
wherein the method is characterized in that overall reinforcement learning is completed earlier than individually performed reinforcement learnings by performing the federated reinforcement learning in coalition with the reinforcement learnings through the sharing of the averaged gradient and the transferring of the learning parameter.

8. The method of claim 7, wherein the gradient is the rate at which the reinforcement learning is performed in the process of performing the reinforcement learning, and is characterized in that a plurality of reinforcement learnings performed through the plurality of device controllers are proceeded at average rate of the plurality of reinforcement learnings by sharing the gradient.

9. The method of claim 7, wherein the method for controlling multiple devices through the federated reinforcement learning, further comprises:
in the plurality of service controllers, controlling the corresponding devices by corresponding learning model generated through the federated reinforcement learning; and
in the plurality of service controllers, providing state information of the devices according to the result of controlling the devices to the federated reinforcement learning managing server,
wherein the method is characterized in that the reinforcement learning is performed again in the plurality of device controllers in case that a re-execution command for the federated reinforcement learning is received from the federated reinforcement learning managing server according to a result of monitoring the state information.

10. The method of claim 7, wherein the method for controlling multiple devices through the federated reinforcement learning, further comprises:
in the federated reinforcement learning managing server, receiving state information of the devices resulting from controlling the devices from the plurality of device controllers,
wherein the method is characterized in that the reinforcement learning is performed again by transmitting the re-execution command for the federated reinforcement learning to the plurality of device controllers in the federated reinforcement learning managing server in case that the received state information of the devices is monitored, and the monitoring result is out of a preset threshold range.
